(19) United States
(12) Patent Application Publication
(10) Pub. No.: US 2006/0250126 A1
(43) Pub. Date: Nov. 9, 2006

(54) Device for creating a region which is substantially free of magnetic field, surrounded by a region with a magnetic field gradient

(75) Inventors: Thijmen Arie Corsjaan Willem van Iterson, Buurmalsen (NL); Bas Gravendeel, Schiedam (NL)

Correspondence Address: HOFFMANN & BARON, LLP, 6900 JERICHO TURNPIKE, SYOSSET, NY, 11791, US

(73) Assignee: Rail Road Systems

(21) Appl. No.: 11/409,126

(22) Filed: Apr. 21, 2006

(30) Foreign Application Priority Data
Apr. 22, 2005 (NL) 1028845

(51) Int. Cl. G01B 7/30

(52) U.S. Cl. 324/207.17

(57) ABSTRACT

A device for keeping electrical insulation joints in rails free of faults is described. These joints form a significant source of faults in rail-borne transport systems in which rail-borne train protection or train detection systems are arranged. The device has magnets for creating a substantially field-free region with a field gradient in all directions leading away from the region. This substantially field-free region is located at the insulating part of an electrical insulation joint. The field gradient ensures that magnetizable material always moves away from the field-free point.

### FIELD OF THE INVENTION

The present invention relates to rail systems in the field of railways.

### BACKGROUND OF THE INVENTION

In addition to a mechanical supporting function, rails can also perform various electrical functions. One of these electrical functions is to carry signal currents for rail-borne train protection and train detection systems. For train detection systems of this type, the rail is divided into sections which have to be mechanically continuous but have to be electrically insulated from one another. Electrical insulation joints are used for this purpose. An electrical insulation joint comprises a sawn-through rail, with the intermediate space being filled by a piece of electrically insulating material. The mechanical supporting function of the rail is restored by using metal plates against the web of the rail, which are arranged in an electrically insulating fashion. One possible embodiment is that in which the metal plates are completely encased by an electrically insulating material.

In particular in these electrical insulation joints, the mechanical interruption of the rail produces a magnetic potential on account of the constant impact of the wheels of trains passing by; alternatively, a magnetic potential of this nature is present from the outset as a result of the initial magnetization of the rails.

The use of the railway infrastructure for various reasons produces abraded iron material which is both electrically and magnetically conductive. Currently, the fact that this dust is electrically conductive gives rise to numerous problems in the railway network. The dust collects at locations where a magnetic potential is present. On account of the fact that the dust is also electrically conductive, when sufficient iron dust is present, an electrical insulation joint may be electrically bridged, thereby losing its function as an electrical insulation joint. This results in a situation which the detection systems detect as an undesirable situation, which will give rise to a “track section occupied” message for at least one of the two track sections. As a result, train travel is no longer possible for as long as the fault situation remains. This results in the track section being unavailable, with all the associated consequences.

There are also other installations and systems next to the track or in the vicinity of the track for which it is undesirable for magnetically and electrically conductive iron dust to be present. One example is a train detection system which is based on magnetic properties of wheels, known as axle counters. If axle counters are used as a train detection system, the track is divided into sections. When a train enters a track section, the number of axles entering the track section is counted and the track section is held as occupied. This occupied message is only cancelled when the same number of axles have moved out of the track section.

FIGS. 9a and 9b show a schematic illustration of one possible embodiment. A transmitter Z and a receiver O are arranged on either side of a rail. They are both connected to a controller T. This controller monitors the number of wheels which have moved past. The axle counter works by the information transmitted by the transmitter Z being received with a defined amplitude by receiver O as a result of magnetic coupling. When no wheel is present between the transmitter Z and the receiver O, the amplitude of the signal at the receiver is low. However, when a wheel W (iron) is present, the coupling is such that the receiver has a sufficient signal to indicate to the controller T that a wheel has been signalled. If the space between the transmitter Z and the rail and between the rail and the receiver O has filled up with iron dust, the receiver O cannot sufficiently distinguish between whether or not a wheel W is present. This leads to the counter malfunctioning, with the result that train travel is no longer possible. Depending on the form of implementation, a message M is emitted that the apparatus is no longer available, or the controller T indicates that the track section is and remains occupied. To prevent these problems, the axle counters have to be cleaned at regular intervals.

### SUMMARY OF THE INVENTION

In general, it is an object of the invention to prevent magnetizable dust from being deposited in a certain critical region.

This object is achieved by using magnets to create a region where in engineering terms the magnetic field is zero (low-field region). This region is located around a theoretically designated point at which the magnetic field has a value of zero. The low-magnetic-field region is in this case surrounded by a region in which there is a field gradient. This field gradient ensures that the magnetic force exerted on magnetizable materials is always directed away from the low-field region. As a result, for example, magnetizable dust which is swirling around is deflected away from the low-field region. Consequently, the low-field region remains free of magnetizable dust.

This principle can be applied in the railway industry. In this case, the low-field region is formed around the insulation piece in an electrical insulation joint.

Using the invention in a railway environment keeps existing rail systems free of faults more successfully and with lower maintenance costs. In general, the use of the device according to the invention allows systems to operate with longer periods between maintenance and inspection work.

One important aspect of the present invention is that by positioning magnets along the rails, the magnetic field configuration around a critical region is influenced in such a manner that the iron dust is effectively moved away from these critical regions in the rail system.

These critical parts occur in, for example, electrical insulation joints, in this case the insulating section of the electrical insulation joint. Axle counters also have a critical region where the presence of too much magnetically and electrically conductive dust leads to the axle counter malfunctioning.

In an embodiment, by using a layer of magnetically nonconductive material or material of poor magnetic conductivity around the magnets allows the iron dust which is thrown up to be removed very easily.

### BRIEF DESCRIPTION OF THE DRAWINGS

The invention is explained by way of example with the aid of the drawings, in which:

FIG. 1 shows a diagrammatic cross section through an electrical insulation joint.

FIG. 2 diagrammatically depicts a side view of an electrical insulation joint.

FIG. 3 shows an arrangement of four magnets indicating a field-free point.

FIG. 4 shows a schematic field profile along a horizontal axis of the arrangement shown in FIG. 3.

FIG. 5 shows a schematic field profile along a vertical axis of the arrangement shown in FIG. 3.

FIG. 6 shows symmetrically positioned fishplates in an arrangement as shown in FIG. 3.

FIG. 7 shows an assembly set-up of permanent magnets on fishplates.

FIG. 8 shows an arrangement with a field sensor, electromagnets and a controller.

FIGS. 9a and 9b schematically show an arrangement of an axle counter and a rail.

### DETAILED DESCRIPTION OF EMBODIMENTS

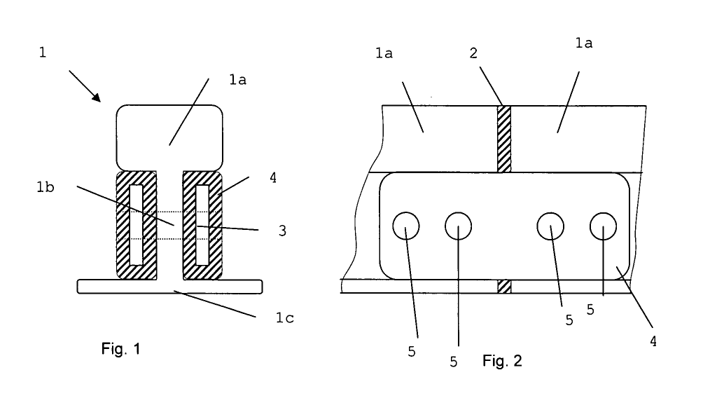

FIG. 1 shows a diagrammatic cross section through an electrical insulation joint. The rail comprises a head 1a, on which train wheels may rest. This head 1a, together with a web 1b and a foot 1c, forms a rail 1 as a whole. Metal fishplates 3 with a plastic casing 4 are arranged against the web of the rail. It should be noted that solid-plastic fishplates also exist.

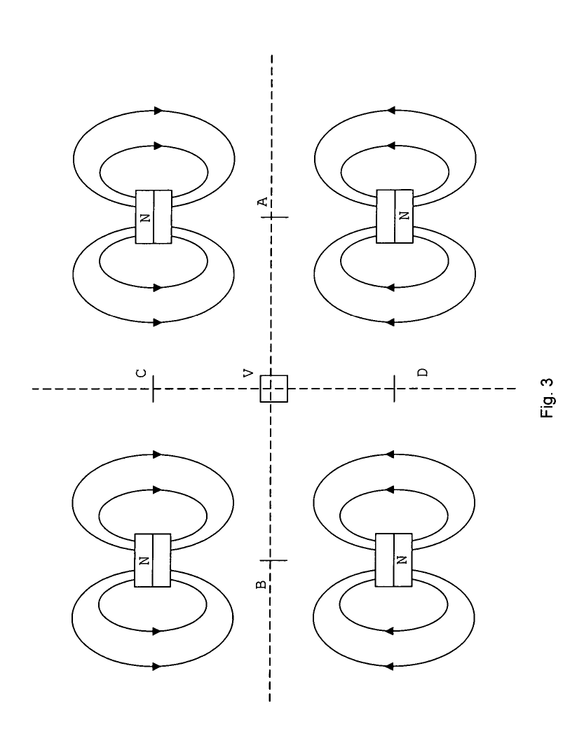

FIG. 2 shows a side view of an electrical insulation joint. Two rails 1 are electrically separated by an insulating intermediate plate 2. The interrupted mechanical supporting function is restored by the rails being mechanical coupled again using two insulating fishplates 4. For this purpose, bolted connections are made via the holes 5 in the fishplates. Obviously, the web 1b of the rails 1 is also provided with the same pattern of holes as the fishplates 4. On account of the intermediate plate 2 and the fishplates 4 being electrically insulating and insulating sleeves (not shown in detail) being arranged in the bolt holes, an electrical isolation is realized between the two rails 1 even if steel (electrically conductive) bolts are used.

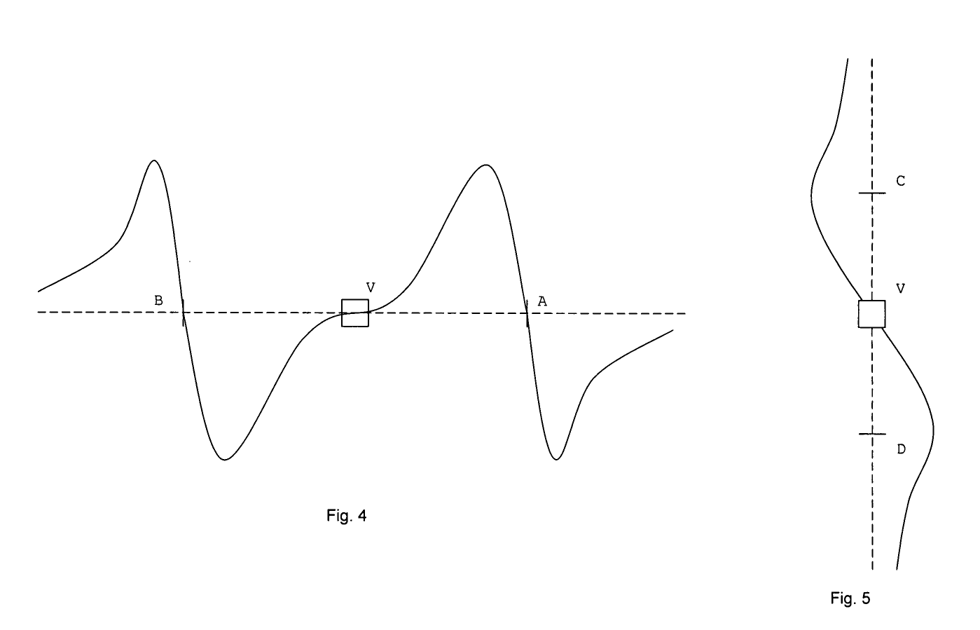

FIG. 3 shows an example of how, in a configuration with four magnets, a field-free point V is made, around which a continuously increasing field (strength) gradient is made on all sides at increasing distance from V. The invention always requires at least two magnets, of which one pole is indicated with N. If two identical magnets are placed directly opposite one another, and positioned symmetrically, such as the magnets above and below point A in FIG. 3, a point in which the magnetic field is zero is formed in A. This can be recognized by vectorial addition of the fields of the two magnets. The field of the top magnet in A is precisely equal to, but of the opposite direction from, that of the bottom magnet. The resulting field in point A is therefore zero. If four identical magnets with a symmetrical field distribution are used and they are positioned symmetrically, as shown in FIG. 3, the result is a field profile as diagrammatically shown in FIG. 4 (profile of the field along line B-A) and FIG. 5 (profile of the field along line C-D). Starting from V, irrespective of the direction a field of increasing absolute value can always be seen. The sign only provides information about the direction of the field. In other words, starting from V, a field gradient which is not equal to zero is present in all directions. A resulting magnetic force in the direction of the increasing field is exerted on magnetizable material in a magnetic field which has a gradient. In its most elemental form, this is known as attraction of iron by a magnet. If magnetizable dust could only move along line B-A, no magnetizable material remains in V, but all of this material will be discharged in the direction of A or B. When the material has reached the vertex in the field, it will move no further; the dust is trapped at the vertex of the field. The same also applies, mutatis mutandis, for C-D. The precise field can be calculated for each arrangement from the laws of physics. The iron dust is pulled away from V until it reaches A or B, where it remains on account of the reversal in field gradient. This position can be cleaned after a certain time.

FIGS. 4 and 5 reveal that V is surrounded in all directions by field gradients; the fields have a constantly increasing amplitude in the direction away from V. This mean that magnetically conductive particles will always move away from V. As a result, V remains free of magnetic dust. In a railway environment, the dust primarily comprises iron-containing particles. In addition to being magnetically conductive, these are also electrically conductive. Therefore, keeping this magnetically conductive dust away therefore automatically mean that this electrically conductive dust is also kept away. Electrically conductive dust which is not magnetically conductive is not trapped in the manner described. In a railway environment, dust that is not magnetically conductive consists of abraded copper and carbon dust originating, for example, from the overhead wire or the third rail in underground railways. This type of dust forms only a small proportion of the total quantity of electrically conductive dust.

Provided that field conductors are positioned symmetrically around a configuration as shown in FIG. 3, a field-free point remains present in the structure. The shape of the field profile does not necessarily remain the same. The field-free point remains surrounded by a field gradient which will divert magnetizable dust away from this field-free point.

The use of permanent magnets gives rise to an embodiment of the basic concept if the magnets are provided with a magnetically nonconductive material (for example plastic). As a result, the attached dust can be removed more easily than if the layer which is not magnetically conductive would be omitted. Cleaning requires a cleaning magnet (optionally provided with a coating) which has a stronger surface field gradient than an electrical insulation joint magnet. This may be an identical magnet which is provided with a thinner coating (or no coating) than the magnets at the fishplate. The field gradient at the surface of the cleaning magnet is greater than that of an electrical insulation joint magnet, and when the two magnets are held against one another the dust is taken by the magnet having the highest field gradient, in this case the cleaning magnet.

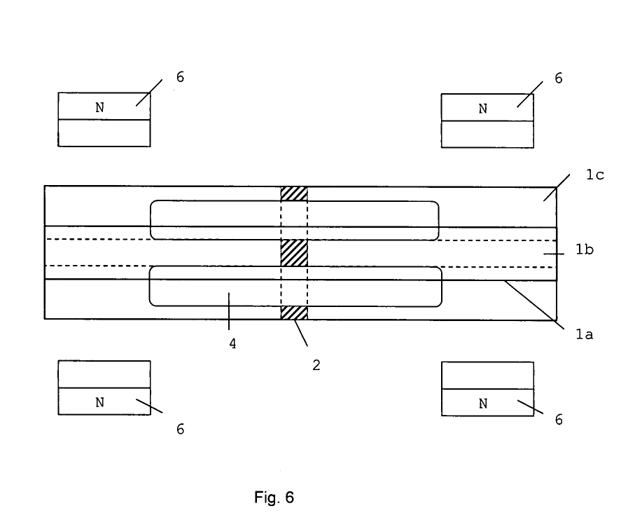

FIG. 6 illustrates a possible positioning of fishplates in the form of a plan view. FIG. 6 shows a rail comprising the components head 1a, web 1b and foot 1c. A fishplate 4 is secured to both sides of the web (cf. also FIGS. 1 and 2). If identical and field-symmetrical magnets 6 are positioned symmetrically around the insulating plate 2, a field-free point is produced at the location of the insulating plate 2, surrounded by a region in which the field is low with a gradient such that swirling magnetically conducting dust moves away from the point of symmetry. Obviously, numerous other forms of positioning are possible.

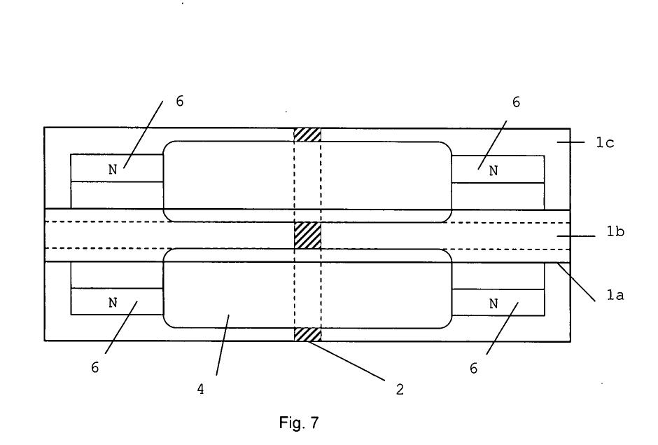

FIG. 7 indicates one possible embodiment. Magnets 6 are secured to ends of the fishplates 4. The fishplates 4 may be magnetically nonconductive, such as a laminated fishplate. If steel fishplates 4 are used in combination with permanent magnets 6, these magnets 6 can be fixed by their own magnetic force. Applying a non-magnetizable and nonconductive layer around the assembly is now as simple as applying a layer of this type around a fishplate without these magnets. If this layer consists of a plastic which is applied using an injection-moulding process in a mould in which the fishplate or the combination of a fishplate with magnets has been placed, this way of attaching magnets offers significant advantages over another, for example mechanical, securing process.

The shape of the fishplates may be different on the side which bears against the web of the rail from the outer side of the fishplate. According to another embodiment, the magnets 6 are positioned in such a manner that the pole direction of the attached magnets is always the same with respect to the web of the rail. These two features result in an invention which cannot be incorrectly assembled.

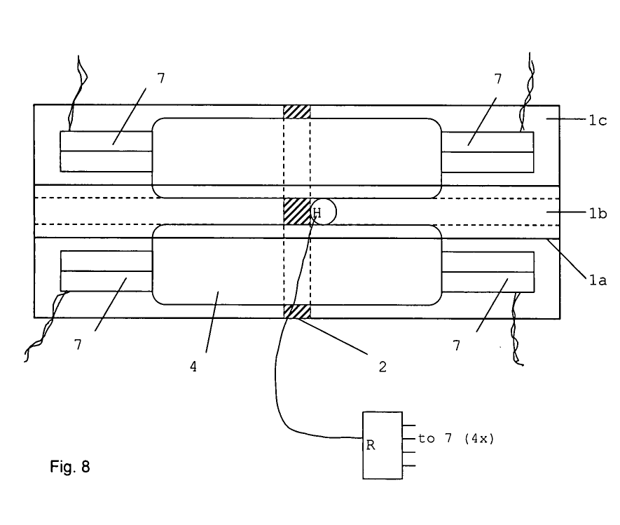

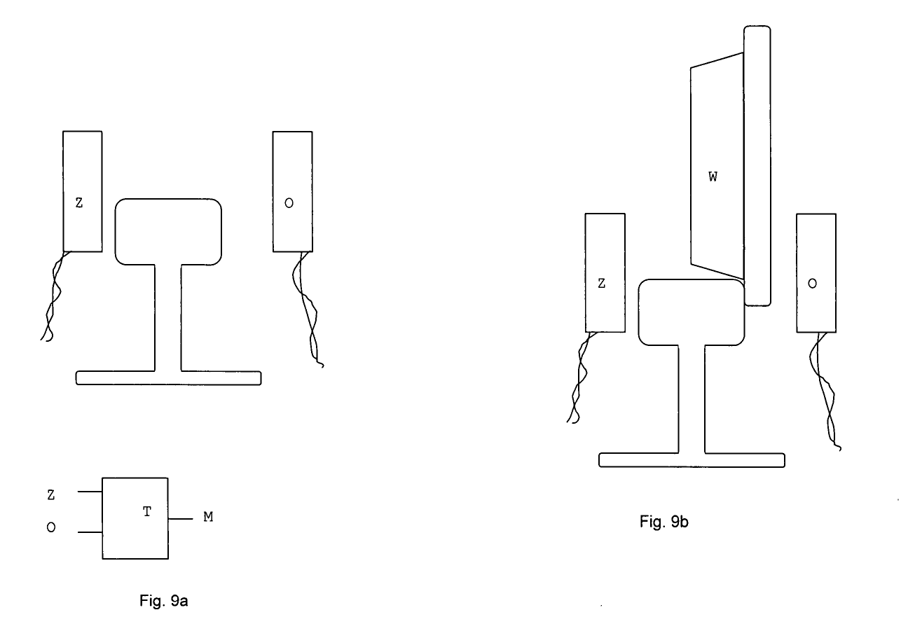

The invention applies to both permanent magnets and electromagnets. If electromagnets are used, the current passing through the magnets can be controlled on the basis of the measured magnetic field at the location of the insulation piece in the electrical insulation joint. FIG. 8 diagrammatically depicts a system of this type. A magnetic field sensor H is positioned at the insulation plate. The information from sensor H is fed to controller R, which in this case has four outputs, each of which is connected to one of the electromagnets (7). Based on the measured level of the magnetic field, the current flowing through each magnet is controlled in such a manner that the field is set to zero at the sensor H. The current may also be controlled on the basis of predetermined magnetic field values. When putting together a control algorithm, use is made of the fact that the current passing through the magnets produces a known field shape. For symmetrical positioning of the magnets and a symmetrical design of the magnets themselves, an identical current passing through the magnets leads to a field pattern which is identical to the field which is built up by four symmetrically positioned, identical permanent magnets. Corrections are required if electromagnets are not positioned symmetrically and/or are not identical. The advantage of using electromagnets compared to an embodiment using permanent magnets is that any magnetization which is already present in the configuration or has built up therein over the course of time is compensated. This magnetization may be present as a result of the manufacturing process of the rails or as a result of the constant striking of the rail by wheels of trains passing by. Eliminating the last residues of magnetization will lead to even less iron dust collecting around the insulation plate.

One particular function which can be incorporated in controller R is demagnetization of the entire magnetic circuit, comprising, inter alia, rail, fishplates (if magnetizable fishplates are used) and base (if steel sleepers are used). Demagnetization of a material can be realized by placing the material in an alternating magnetic field. In this case, it is necessary to start with a sufficiently high field. During the polarity reversal of the field, a lower amplitude is selected for each new cycle, until the amplitude has reached a value of zero. At that moment, the structure is magnetically neutral and dust which is already attached to the structure will fall off, leaving the joint free of magnetizable dust. Magnetizable dust swirling along will not stick to the joint. The structure has now become maintenance-free. This is an advantage in particular at locations which are difficult to reach or at locations where the rail traffic over the track has been very busy.

According to one embodiment, the electromagnets in an embodiment as described above are only activated when a train moves past and the system returns to the unenergized state when the train has passed. The dust then remains attached to the magnets while the train is passing but drops off the magnets after the train has passed. Dust only remains attached if a certain residual magnetism is present.

According to yet another embodiment, the embodiment described above is combined with the demagnetization function. Each time a train passes, the system is completely demagnetized within a time required for a train to pass. As a result, the system is completely demagnetized after each time a train has passed. There is virtually no need then to clean the structure.

According to another embodiment, the electrical energy required for the system described above is obtained from the movement of the passing train, using an appropriate converter for converting the energy from the movement of the train into electrical energy.

Another possibility is for the electrical energy to be obtained from the movement of the track resulting from the train passing.

While there have been shown and described different embodiments of the present invention, it will be obvious to those skilled in the art that various changes and modifications may be made therein without departing from the scope of the invention as defined in the appended claims.

1. A device comprising magnets with a specific field shape and field size, wherein the magnets together realize a point which is free of magnetic field at a defined spatial location, surrounded by a region with a field gradient which is such that magnetizable particles move away from the field-free point.

2. The device of claim 1, wherein the point which is free of magnetic field and the surrounding region are realized with a geometrically symmetrical arrangement of mutually identical magnets.

3. The device of claim 1, wherein the point which is free of magnetic field and the surrounding region are realized with an arrangement that is not completely geometrically symmetrical, by adapting the ratio of the size and/or the orientation of the field of the magnets with respect to one another.

4. The device of claim 1, wherin the point which is free of magnetic field and the surrounding region are realized with at least two magnets.

5. The device of claim 1, comprising at least one magnetic field conductor, for example an iron field conductor, for example situated around the point which is to be free of magnetic field and the surrounding region.

6. The device of claim 5, wherein the magnets and the field conductor are formed as a single unit by injection moulding or press moulding.

7. The device of claim 1, wherein the magnets are at least partially encased by a magnetically nonconductive material.

8. The device of claim 1, wherein at least one of the magnets is designed as a permanent magnet.

9. The device of claim 1, wherein at least one of the magnets is designed as an electromagnet.

10. The device of claim 9, including means for demagnetization of the device.

11. The device of claim 9, wherein the device is provided with a circuit configured to control the current flowing through each electromagnet.

12. The device of claim 11, wherein the circuit is configured to control the current on the basis of the magnitude of the magnetic field in the point which is to be free of magnetic field or the surrounding region.

13. The device of claim 11, wherein the circuit controls the current on the basis of predetermined magnetic field values.

14. The device of claim 1, wherein the magnets are integrated in a magnetically nonconductive fishplate, such as a laminated fishplate.

15. An electrical insulation joint in a rail, comprising an insulating intermediate piece, and a device of any of claims 1, wherein the point which is free of magnetic field and at least part of the surrounding region are in the plastic intermediate piece of the electrical insulation joint.

16. An axle counter, comprising a transmitter and a receiver separated by a space between them, and a device of any of claims 1, wherein the point which is free of magnetic field and at least part of the surrounding region are in the space between the transmitter and receiver.
